(19) United States
(12) Patent Application Publication
(10) Pub. No.: US 2017/0323344 A1
(43) Pub. Date: Nov. 9, 2017

(54) CUSTOMER SEGMENTATION USING CUSTOMER VOICE SAMPLES

(71) Applicant: International Business Machines Corporation, Armonk, NY (US)

(72) Inventor: Leho Nigul, Richmond Hill (CA)

(21) Appl. No.: 15/144,933

(22) Filed: May 3, 2016

(51) Int. Cl. G06Q 30/02; G10L 25/48

(52) U.S. Cl. CPC G06Q 30/0269; G10L 25/48

(57) ABSTRACT

Embodiments of the present invention provide systems and methods for customer segmentation. Customers can use mobile devices to interact with e-commerce retailers via Internet connections, in order to shop for products and services. E-commerce retailers aim to provide a more personalized shopping experience. Based on voice interactions with a customer, e-commerce retailers may apply embodiments of the present invention to store voice segments of a customer; assign voice segments to the customer; analyze the customer's spending behaviors; assign a customer segment to the customer based on the customer's spending behaviors; and generate offers to the customer based on the customer segment.

### BACKGROUND OF THE INVENTION

The present invention relates generally to the field of telecommunications technology and more specifically to using voice samples to perform customer segmentation.

Mobile devices can be used for e-commerce shopping. Thus, mobile device users can search for and buy products via the Internet from their mobile devices. Retailers (across all media) may face very strong competition and thus, try to provide personalized experiences to the online shoppers using products and incentives, which the online shoppers may be interested in.

### SUMMARY

According to one embodiment of this present invention provides, a method for customer segmentation, comprising: receiving, by one or more processors, a first voice interaction from a customer; analyzing, by one or more processors, a set of voice data deriving from the first voice interaction; generating, by one or more processors, a voice signature based on the analyzed set of voice data wherein the voice signature is assigned to a customer segment; and outputting, by one or processors, a set of offers to the customer based on the assigned customer segment.

Another embodiment of the present invention provides a computer program product for customer segmentation, based upon the method described above.

Another embodiment of the present invention provides a computer system for customer segmentation, based upon the method described above.

### BRIEF DESCRIPTION OF THE DRAWINGS

FIG. 1 is a functional block diagram illustrating a communication processing environment, in accordance with an embodiment of the present invention;

FIG. 2 is a functional block diagram illustrating the flow of data between a customer and e-commerce retailer, in accordance with an embodiment of the present invention;

FIG. 3 is a flowchart depicting the operational steps of e-commerce module 120, in accordance with an embodiment of the present invention; and

FIG. 4 depicts a block diagram of internal and external components of a computing device, in accordance with an embodiment of the present invention.

### DETAILED DESCRIPTION

With the proliferation of mobile devices (and the accompanying mobile device usage), searches on retailer websites are increasingly initiated and controlled using voice commands. Therefore, the voice tidbits (which are contained within the voice commands) are pieces/segments of voice data which, which may be captured by the retailer and leveraged for shopper segment matching. The methods and systems described in the embodiments of the present disclosure provide e-commerce solutions via customer segmentation.

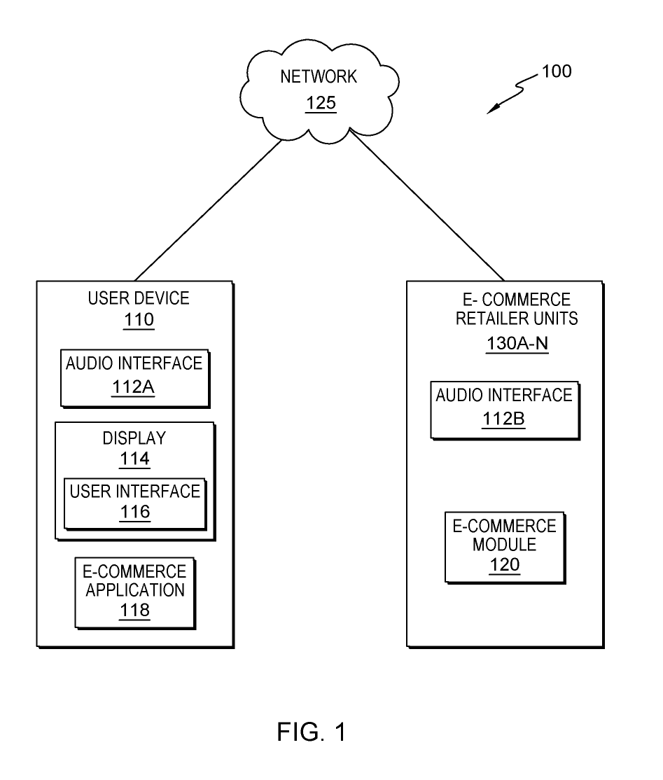

The present invention will now be described in detail with reference to the Figures. FIG. 1 is a functional block diagram illustrating a communication processing environment, generally designated 100, in accordance with one embodiment of the present invention. FIG. 1 provides only an illustration of implementation and does not imply any limitations with regard to the environments in which different embodiments may be implemented. Modifications to data processing environment 100 may be made by those skilled in the art without departing from the scope of the invention as recited by the claims. In this exemplary embodiment, data processing environment 100 includes user device 110 and e-commerce retailer units 130A-N, interconnected via network 125.

Network 125 may be a local area network (LAN), a wide area network (WAN) such as the Internet, the public switched telephone network (PSTN), a mobile data network (e.g., wireless Internet provided by a third or fourth generation of mobile phone mobile communication), a private branch exchange (PBX), any combination thereof, or any combination of connections and protocols that will support communications between user device 110 and e-commerce retailer units 130A-N, in accordance with embodiments of the invention. Network 125 may include wired, wireless, or fiber optic connections.

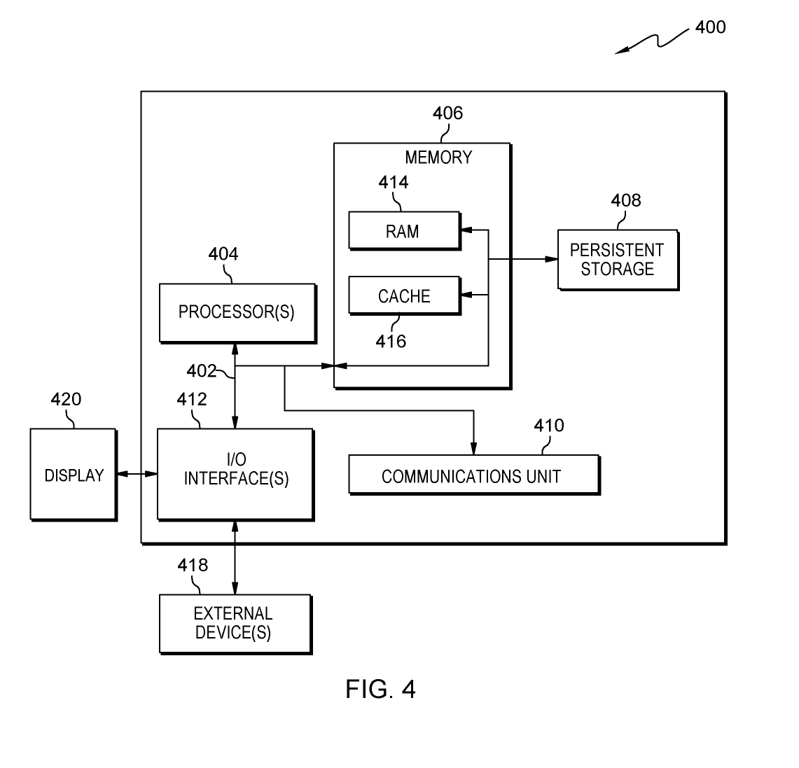

User device 110 is a mobile device which can communicate with e-commerce retailer units 130A-N through voice and Internet communication. In other embodiments, user device 110 may be a laptop computer, a tablet computer, a thin client, or personal digital assistant (PDA). In general, user device 110 may be any mobile electronic device or mobile computing system capable of sending and receiving data, and communicating with a receiving device over network 125. User device 110 may include internal and external hardware components, as depicted and described in further detail with respect to FIG. 4. User device 110 contains audio interface 112A, user display 114, user interface 116, and e-commerce application 118.

E-commerce retailer units 130A-N contain audio interface 112B and e-commerce module 120. Electronic commerce is commonly referred to as e-commerce. E-commerce retailer units 130A-N either trade or facilitate the trade of products or services using the Internet. E-commerce encompasses technologies such as mobile commerce, electronic funds transfer, supply chain management, Internet marketing, online transaction processing, electronic data interchange (EDI), inventory management systems, and automated data collection systems. Modern e-commerce typically uses the World Wide Web for at least one part of the transaction's life cycle, although e-mail can also be used. E-commerce retailer units 130A-N may employ some or all of the following elements and/or functionalities: (i) online shopping web sites for retail sales directed towards customers; (ii) providing or participating in online marketplaces, which process third-party business-to-customer (B2C) or customer-to-customer (C2C) sales; (iii) business-to-business (B2B) buying and selling; (iv) gathering and using demographic data through web contacts and social media; (v) business-to-business electronic data interchange; (vi) marketing to prospective and established customers by e-mail or fax; and (vii) engaging in “pretailing” for the launch of new products and services. A repository utility (or its functional equivalent) within e-commerce retailer units 130A-N stores voice data from e-commerce module 120. The stored voice data is accessed and further analyzed by e-commerce module 120 when a user is searching through the Internet content of e-commerce retailer units 130A-N via user device 110.

In this exemplary embodiment, audio interfaces 112A and 112B include a recording component in order to record audio deriving from a voice interaction between a customer and e-commerce retailer units 130A-N; a speaker component in order to output audio to a listener; and a microphone component in order to receive audio from a listener. Audio interface contains an audio codec device (not pictured) that is configured to code and decode digital data streams of audio. User device 110 and e-commerce retailer units 130A-N contain audio interfaces 112A and 112B, respectively.

In this exemplary embodiment, user display 114 may be composed of, for example, a liquid crystal display screen, an organic light emitting diode display screen, or other types of display screens. User display 114 contains user interface (UI) 116.

User interface 116 may be for example, a graphical user interface (GUI) or a web user interface (WUI) and can display text, documents, web browser windows, user options, application interfaces, and instructions for operation, and includes the information (such as graphics, text, and sound) a program presents to a user and the control sequences the user employs to control the program. User interface is capable of receiving data, user commands, and data input modifications from a user.

E-commerce application 118 is a program which resides in user device 110 and allows the user of user device 110 to directly communicate with e-commerce retailer units 130A-N. E-commerce application 118 can be either a mobile application format, a software application format, or web application format. A mobile application (which is commonly referred to as a “mobile app”) is a computer program designed to run on mobile devices such as smartphones and tablet computers. These mobile applications can serve as a web browser; email client; calendar; mapping program; and a means of obtaining music, other media, or more mobile apps. In contrast to mobile apps, software applications run on a computing unit and web applications run in mobile web browsers (as opposed to directly running on the mobile device).

In this embodiment, E-commerce module 120 is implemented when a user of user device 110 is verbally communicates with e-commerce retailer units 130A-N. During the verbal communication, the voice tidbits (which are contained within the voice commands) of the user are recorded by e-commerce module 120. The recorded voice tidbits are eventually associated with a specific customer segment by a customer segmentation engine. E-commerce module 120 does not match voice tidbits to any specific user-identifying information in order to avoid privacy concerns, while adding the voice tidbits to a specific customer segment. The recorded voice tidbits derive from voice commands, which are analyzed by voice analyzer 220 and given a voice signature. The voice signature is a type of biometric authentication used as a form of identification which is distinct and unique to a specific customer. The voice signature is stored in a database and the voice signature creates a specific customer segment assigned to the customer. In one embodiment, customer segmentation is applied because only a percentage of the general population is statistically likely (i.e. is likely above a threshold) to purchase products and/or services from e-commerce retailer units 130A-N. Thus, e-commerce retailer units 130A-N leverages customer segmentation to focus on segments of the population which will likely purchase the offered goods and/or services. E-commerce module 120 considers the needs of customers (i.e. the user of user device 110) and businesses (i.e., e-commerce retailer units 130A-N) via customer segmentation in order to a) sort customers into groups, b) understand needs of the customers, and c) understand the capabilities of the business such that the needs of the customer are met in a statistically significant number of scenarios, e.g., in a majority of scenarios. In the example above, the specific customer segment is the “high value electronics customer” segment. The advantages of customer segmentation enable a business to: identify the most and least profitable customers; focus on marketing to customers most likely to purchase products and services from the business; improve customer service and satisfaction; identify new products, groups customers into defined categories; and utilize resources more effectively. Individual customers may have differing needs. The customer segmentation capability of e-commerce module 120 permits customers (such as the user of user device 110) to obtain information on potentially desirable product and services upon dividing the customers into customer segments sharing similar needs. E-commerce retailer units 130A-N may customize its treatment of each customer segment and product provider such that their respective needs are better met. For example, products and services for each customer segment can be customized by aiming marketing at a particular segment and focusing on the most profitable scenarios. Businesses (such as e-commerce retailer units 130A-N) usually target a large customer segment with many people in it or focus on a niche segment, which will have fewer people in it, but who can be served well by the business. Niche segments may prove to be lucrative ventures and thus, can be of interest to a business.

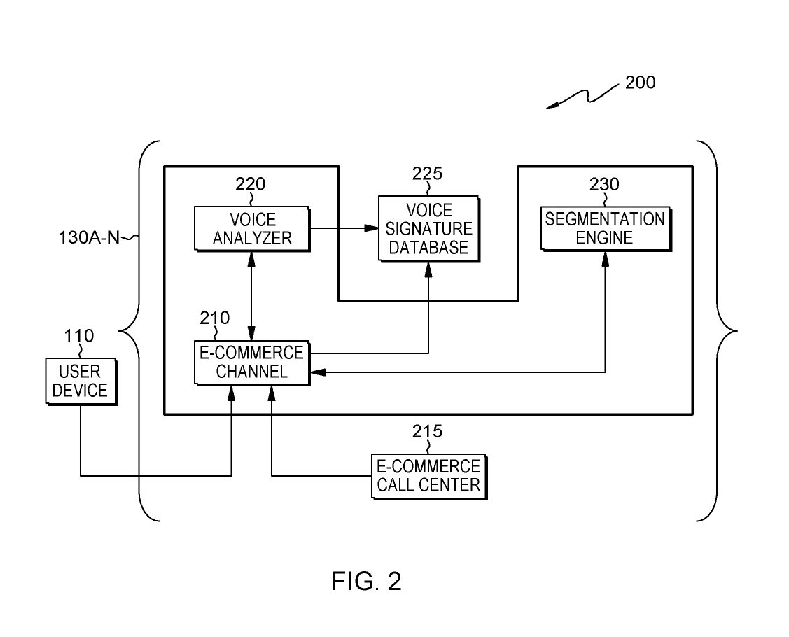

FIG. 2 is a functional block diagram, 200, illustrating the flow of data between a customer and an e-commerce retailer, in accordance with an embodiment of the present invention.

In general, FIG. 2 depicts additional components of e-commerce module 120 and their respective connectivity between each other and user device 110, in accordance with an embodiment of the present invention.

In this exemplary embodiment, the customer is the user of user device 110 and the business is e-commerce retailer units 130A-N. E-commerce retailer units 130A-N contain e-commerce call center 215, voice signature database 225, and e-commerce module 120. E-commerce call center 215 is a centralized office used for receiving or transmitting a large volume of requests by telephone. In this exemplary embodiment, the telephone used to communicate with e-commerce call center 215 is user device 110.

E-commerce module 120 contains e-commerce channel 210, voice analyzer 220, and segmentation engine 230 as depicted within the solid line boundaries in FIG. 2. E-commerce channel 210 is a utility configured to provide voice communication between user device 110 and e-commerce retailer units 130A-N. E-commerce channel 210 in FIG. 2 is depicted as a single entity. In other embodiments, e-commerce channel 210 may be more than a single entity. Voice analyzer 220 bi-directionally communicates with e-commerce channel 210 in order to analyze voice patterns and generate a voice signature. Segmentation engine 230 assigns a voice signature, which is derived from customer voice tidbits, to a customer segment.

Voice analyzer 220 is configured to perform voice analysis on voice/audio data for purposes other than linguistic content. Voice analysis is performed on the data deriving from the recorded voice tidbits and voice signatures. For example, the recorded voice tidbits (and voice signatures) are in a waveform. (In other instances, the recorded voice tidbits are in encoded in different formats.) The application of voice analysis techniques, such as inverse filtering or electroglottography on the recorded voice tidbits (which are in a waveform), helps provide insights into the identity of a person and behavioral patterns. In this example, voice analyzer 220 searches for shifts and correlations within the record voice tidbits in order to understand customer behavioral patterns. Waveforms are described in terms of certain wave properties such as amplitude, frequency, and pitch associated with sound waves. In an embodiment, a given behavior or emotional state is correlated with a certain amplitude, frequency, and/or pitch associated with a given waveform, whereas another behavior or emotional state correlates with another amplitude, frequency, and/or pitch of another waveform. In some embodiments, patterns of changes present in a waveform are identified and correlate to behavior or emotional state. For example, the pitch of a customer shifts from a lower pitch to a higher pitch indicating that their level of excitement regarding a product has increased. In general, a shift in these correlated wave properties is indicative of a shift in customer behavior patterns and emotional states. Note: There is a difference between speaker recognition (i.e., recognizing who is speaking) and speech recognition (i.e., recognizing what is being said). These two terms are not to be confused, and, further, as used herein, “voice recognition” can be used for both. The truthfulness or emotional state of a speaking customer may be determined using Voice Stress Analysis or Layered Voice Analysis. When accurate determinations on truthfulness and emotional state can be made on the speaking customer, deeper insights can be gained into customer preferences. Based on speech patterns such as tone of voice or direct statements, voice analyzer 220 can generate a voice signature based on the customer's voice tidbits. The voice signature can be used to determine a customer's preferences, dislikes, and other customer habits. For example, a customer speaks in a discernably louder voice when he is interested in a product and in a discernably lower voice when he is not interested in a product. The waveforms associated with the voice tidbits of the customer when he is interested in the product are compared to the waveforms associated with the voice tidbits of the customer when he is not interested in the product. The waveforms in these two scenarios are different and voice analyzer 220 detects this difference in the waveforms in these two scenarios while associating one emotional sentiment (i.e., more interest in a product) with one set of waveforms and associating another emotional sentiment (i.e., less interest in a product) with another set of waveforms. Thus, voice analyzer 220 is able to detect or assist e-commerce retailer units 130A-N in detecting the customer's speaking mannerisms, wherein these findings can be incorporated to generate a voice signature for the customer.

Segmentation engine 230 performs the analytics to perform customer segmentation based on voice data. More specifically, segmentation engine 230 sorts through known customer segments and assigns a customer segment to a customer based on multiple factors (e.g., customer habits, speaking mannerisms, supplier trends, voice tidbits, etc.). Segmentation engine 230 is an analytics utility of e-commerce module 120 that parses a set of established customer segments and stored voice signatures. Furthermore, a sorting function is applied which categorizes the voice signatures. Segmentation engine 230 can create new customer segments based on new market conditions and pre-configuration by e-commerce retailer units 130A-N. In this embodiment, e-commerce retailer units 130A-N define the customer segments based on variables/information deemed to be important to e-commerce retailer units 130A-N. (These important variables are preconfigured and predefined by e-commerce retailer units 130A-N, wherein e-commerce retailer units 130A-N.) Due to the important variables/information to e-commerce retailer units 130A-N not being precisely defined and the anonymous nature of the customers (as described in the embodiments of this invention), populating a relevant/appropriate customer segment to the customer may prove to be challenging. In general, e-commerce retailer units 130A-N possess limited information (e.g., “customers who spend more than $100 on electronics”) yet are not in possession of the names of the customers. Customer segmentation involves putting customers into groups, ascertaining the needs of the customers, and determining the capabilities of the business to meet the needs of the customer. Furthermore, such customer segmentation allows e-commerce module 120 to make an offer to the customer and identify a niche market without knowledge of a user's identity beyond their use of and association with a user device 110. By definition, niche markets are a specific and well-defined market overlooked by the competitors of e-commerce retailer units 130A-N. In some instances, customer segmentation may allow e-commerce retailer units 130A-N to command a higher price for certain products. A promotional offer, which can be presented to a customer, is based on analytics which considers the factors described above and assigns a customer segment to the customer. For example, the offer sent by e-commerce module 120 is targeted towards niche markets by offering products and services to fit specific needs to the customer. For B2B scenarios, customer segmentation of business markets, can be grouped and analyzed by: (i) ascertaining industry sector of the business; (ii) size and location of the business; (iii) technology and application of the products offered by the business; (iv) the size and frequency of orders placed by the business; and (v) behaviors of the business in terms of loyalty to prior customers and attitude towards risk. For B2C scenarios, customer segmentation markets of the customers, can be grouped and analyzed by: (i) location of the customer; (ii) profiles based on as age, gender, income, occupation, education, social class, etc. of the customer; (iii) attitudes and lifestyles of the customer; and (iv) buying behavior of the customer including product usage, brand loyalty and the desired benefits from the product or service. Within segmentation engine 230, multiple customer segments are stored. The analytics performed on the voice bits, voice signature, customer habits, etc. aim to find an appropriate customer segment match for the customer amongst the stored customer segments. For example, e-commerce retailer units 130A-N is a computer manufacturer and performs customer segmentation (on potential customers) to optimize its products and marketing mix. The customer is assigned a “family” customer segment by e-commerce module 120. A typical offer, wherein the customer shops on a computer manufacturer website, is presented to the customer. The offer is based on the “family” customer segment where the offer involves promotional items containing general and educational software, basic games, a digital versatile disk (DVD) player, “safe” access to the Internet, and email accounts for each member of the family. The promotional items included in this offer are targeted towards the “family” customer segment. If a different customer segment is assigned to the customer, then a different offer may be presented to the customer. One set of voice tidbits and other factors may lead to one customer segment while another set of voice tidbits and other factors may lead to another customer segment.

Voice tidbits are anonymized and processed based on one or more customer interactions between the user of user device 110 and e-commerce retailer units 130A-N for customer segmentation. The user of user device 110 is a customer interested in the products and services offered by e-commerce retailer units 130A-N. When the customer interacts with e-commerce retailer units 130A-N through e-commerce channel 210, which potentially involves “voice communication” (e.g., voice commands through user device 110, interaction with e-commerce call center 215, etc.), e-commerce module 120 processes the customer voice tidbits to generate a customer voice signature. Voice tidbits are contained within a customer's voice commands and are transformed into a data format amenable for further processing. This data format forms a captured voice signature to be associated with a customer. The captured voice signature is stored in a repository structure such as voice signature database 225. The voice signature can be sent directly to voice signature database 225 from e-commerce channel 210 or indirectly to voice signature database 225 from e-commerce channel 210 via voice analyzer 220 (which performs analysis on the customer voice). The voice signature of a customer is assigned to a specific customer segment at segmentation engine 230 based on voice tidbits. This specific customer segment is used as data which can be further applied upon e-commerce module 120 receiving new customer interactions.

The next time the same customer communicates with the e-commerce retailer units 130A-N (i.e., the new customer interaction), voice analyzer 220 matches the customer to the customer's voice signature which is already in voice signature database 225. Based on the newly received voice tidbits which has been matched to data in voice signature database 225 and the matched voice signature which has already been assigned to a specific customer segment, segmentation engine 230 presents specific customer segment offer(s), promotion(s), or advertisement(s) to the customer (who happens to be the user of user device 110) and to e-commerce call center 215. If a customer contacts e-commerce call center 215, then e-commerce call center 215 can present the specific customer segment offer(s), promotion(s), or advertisement(s) to the customer.

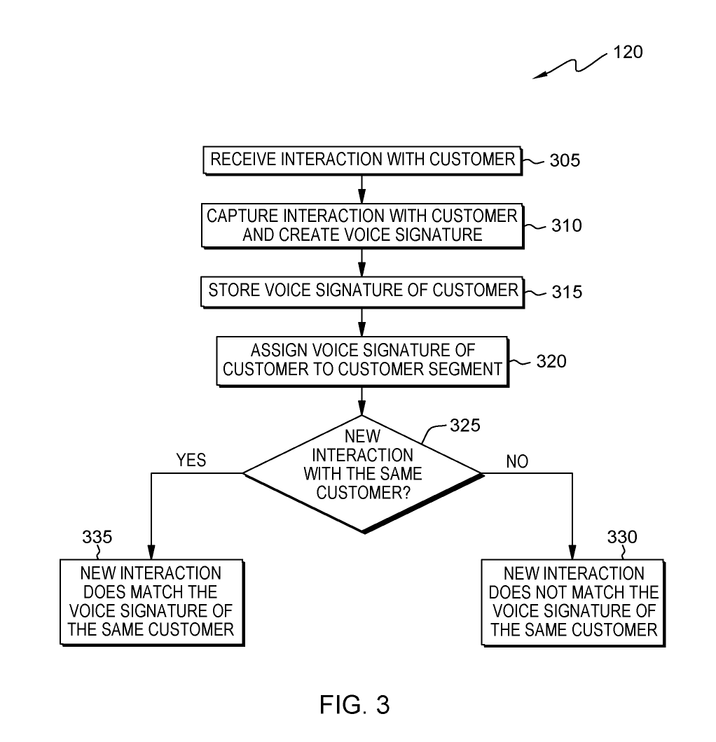

FIG. 3 is a flowchart depicting the operational steps of e-commerce module 120, in accordance with an embodiment of the present invention.

In step 305, e-commerce module 120 receives an interaction with a customer. The interaction involves voice communications between the customer (i.e., the user of user device 110) and e-commerce retailer units 130A-N. Voice tidbits of customer derive from voice commands and other types of communicative elements which convey customer preferences to e-commerce retailer units 130A-N via e-commerce module 120. E-commerce channel 210 is a component of e-commerce module 120, which facilitates voice communication between customer and e-commerce retailer units 130A-N. In other embodiments, e-commerce module 120 can facilitate voice communication between customer and e-commerce call center 215.

In step 310, e-commerce module 120 captures the interaction with the customer and creates a voice signature. The voice tidbits of customer and other parties involved in the interaction are captured and stored as data. The interaction with customer may include voice tidbits from e-commerce call center 215 or other parties. Voice analyzer 220 is a component of e-commerce module 120 that analyzes and sorts through the data deriving from the voice tidbits of the entire interaction. Upon analyzing and sorting through the data deriving from the voice tidbits, e-commerce module 120 associates the relevant voice tidbits to customer and creates a voice signature of the customer.

In step 315, e-commerce module 120 stores a voice signature of the customer. E-commerce retailer units 130A-N typically have many customers or potential customers. Each customer has a distinct voice signature in order to distinguish the customers from each other. To keep a record of these voice signatures, voice signatures are stored in voice signature database 225 of e-commerce retailer units 130A-N. E-commerce module 120 created a voice signature of the customer in data format (see step 310) to be sent to voice signature database 225. At a future point in time, e-commerce module 120 and e-commerce retailer units 130A-N can access voice signature database 225 in order to find a potential customer of interest.

In step 320, e-commerce module 120 assigns the voice signature of the customer to a customer segment. Customer segmentation is a process which creates a customer segment based on market analysis in conjunction with at least the needs of the customer and the capabilities of a business (e-commerce retailer units 130A-N). Further details with respect to customer segmentation is described in the discussion pertaining to e-commerce module 120 in FIG. 1 and to segmentation engine 230 in FIG. 2. Previously analyzed voice tidbits are further analyzed to determine buying habits and other factors relevant to customer behavior. From the example above, the customer is an anonymous shopper who bought a large amount of electronics merchandise online and issued many voice commands via user device 110. Voice tidbits can be indicative of the customer's preferences which brings in an additional dimension for segmentation engine 230 to consider. The customer preferred products that are energy efficient and contain multi-purpose activity (e.g., a phone charging station which is also an alarm clock). Customer segmentation takes into consideration the voice commands and buying preferences of the customer to determine an appropriate customer segment. In this example, e-commerce module 120 determines “high value electronics customer” segment as the appropriate customer segment. Voice signature of the customer is assigned the appropriate or the most appropriate matching customer segment among the set of established customer segments. For example, the customer is an anonymous user who is shopping online at website X and buys 2000 dollars' worth of electronics merchandise. While browsing and shopping via user device 110, the customer issues multiple voice commands. A system implemented by e-commerce retailer units 130A-N captures at least a portion of the multiple voice commands as voice tidbits. The voice tidbits are added to the “high value electronics customer” segment.

In decision step 325, e-commerce module 120 determines if there is a new interaction with the same customer. The interaction is examined by e-commerce module 120 with the goal of accurately associating the incoming voice tidbits with a voice signature contained within voice signature database 225 by invoking voice analyzer 220. Additional information is not required to find a potential customer within voice signature database 225, which allows anonymity to be maintained. This is done by analyzing newly received voice tidbits and comparing these newly received voice tidbits to stored voice signatures. There may be no further interactions containing voice tidbits which can be accurately associated with a voice signature contained within voice signature database 225. If e-commerce module 120 receives an incoming voice interaction which can be matched to a voice signature stored in voice signature database 225 (i.e., decision step 325, yes branch), then e-commerce module 120 proceeds to step 335. If e-commerce module 120 receives an incoming voice interaction which cannot be matched to a voice signature in voice signature database 225 (i.e., decision process 325, no branch), then e-commerce module 120 proceeds to step 330.

In step 330, e-commerce module 120 determines the new interaction does not match the voice signature of the same customer. Thus, e-commerce module 120 cannot match the customer to its respective voice signature upon determining there is no new interaction with the customer. In one embodiment, another customer contacts e-commerce retailer units 130A-N. The voice tidbits of this interaction goes through e-commerce channel 210. These voice tidbits are analyzed and e-commerce module 120 is unable to associate these voice tidbits with the voice signature of the customer (as the customer is not a party in this new interaction). The newly analyzed voice tidbits do not match the voice signature of the customer (which is already stored in voice signature database 225). The new customer will be given a voice signature to be stored in voice signature database 225 and assigned customer segment from the voice signature.

In step 335, e-commerce module 120 determines the new interaction does match the voice signature of the same customer. Thus, e-commerce module 120 can match the customer to its respective voice signature upon determining there is a new interaction with the same customer. The customer contacts e-commerce retailer units 130A-N for a second time. The voice tidbits of this new interaction goes through e-commerce channel 210. These voice tidbits are analyzed and e-commerce module 120 is able to associate these voice tidbits with the voice signature of the customer (as the customer is a party in this new interaction). The voice tidbits of the new interaction are analyzed by voice analyzer 220. The resultant voice analysis is compared to voice signatures found in voice signature database 225. If the voice signature of the customer is already stored in voice signature database 225, then e-commerce module 120 matches the newly analyzed voice tidbits with the voice signature of the customer. In this scenario, the voice signature of the customer is already assigned to a customer segment. In some embodiments, the matching of the voice signature of the customer triggers specific offers, promotions, and/or advertisements from a retailer to be sent to the customer, via user device 110, based on the assigned customer segment. The customer segment (as described above) is derived from the content of the voice tidbits and/or voice signatures of the associated customer in part to gain insight into the customer's preferences. For example, in continuation of the example from step 320, the same customer goes back to website X. Based on the prior use of website X by the user and the matched voice tidbits associated with the “high value electronics customer” segment, the user of website X is offered a promotion to a buy the latest gadget from vendor A.

In general, customer segmentation can be dynamic. Analysis that yields a particular customer segment in one instance, may yield another customer segment in a second instance upon e-commerce module determining new “market conditions” (e.g., modified customer preferences). Thus the customer segment to which a given user belongs can change as the preferences and capabilities of the customer and e-commerce business change over time.

FIG. 4 depicts a block diagram of internal and external components of computing device 400, such as the mobile devices of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Program instructions and data used to practice embodiments of the present invention may be stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of network 125. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to computing device 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., software and data, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device to cause a series of operational steps to be performed on the computer, other programmable apparatus or other device to produce a computer implemented process, such that the instructions which execute on the computer, other programmable apparatus or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for customer segmentation, comprising:
receiving, by one or more processors, a first voice interaction from a customer;
analyzing, by one or more processors, a set of voice data deriving from the first voice interaction;
generating, by one or more processors, a voice signature based on the analyzed set of voice data wherein the voice signature is assigned to a customer segment; and
outputting, by one or processors, a set of offers to the customer based on the assigned customer segment.

2. The method of claim 1, wherein receiving the first voice interaction, comprises:
capturing, by one or more processors, using at least one channel, at least some portions of the first voice interaction between the customer and an e-commerce unit, as the set of voice data.

3. The method of claim 1, wherein analyzing, by one or more processors, the set of voice data comprises:
determining, by one or more processors, patterns of the customer based on the voice analysis, wherein the patterns of the customer are based on at least purchasing preferences and purchasing history;
determining, by one or more processors, patterns of an e-commerce unit based on at least supplier capability to provide products and services to the customer; and
sending, by one or more processors, the voice signature associated with the customer to a database.

4. The method of claim 1, wherein assigning the voice signature to a customer segment, comprises:
creating, by one or more processors, a profile comprising the voice signature of the customer and customer patterns of the customer, wherein the customer patterns are at least purchasing preferences and purchasing history; and
responsive to analyzing the profile of the customer and considering an ability of an e-commerce unit to meet demands of the customer, assigning, by one or more processors, the customer segment to the customer.

5. The method of claim 4, wherein assigning the customer segment to the customer, comprises:
dynamically generating, by one or more processors, customer segments associated with the customer upon receiving new information pertaining to at least one of the customer and the e-commerce unit; and
determining, by one or more processors, niche markets in conjunction with capabilities of the e-commerce unit by examining the customer patterns.

6. The method of claim 1, further comprising:
receiving, by one or more processors, a second voice interaction associated with the customer through at least one channel;
analyzing, by one or more processors, at least some portions of the second voice interaction using a voice analyzer; and
matching, by one or more processors, the at least some portions of the second voice interaction, with the generated voice signature.

7. The method of claim 6, further comprising:
responsive to matching the at least some of the portions of the second voice interaction with the voice signature, associating, by one or more processors, the customer segment assigned to the customer, based on the second voice interaction.

8. A computer program product for customer segmentation, comprising:
a computer readable storage medium and program instructions stored on the computer readable storage medium, the program instructions comprising:
program instructions to receive a first voice interaction from a customer;
program instructions to analyze a set of voice data deriving from the first voice interaction;
program instructions to generate a voice signature based on the analyzed set of voice data wherein the voice signature is assigned to a customer segment; and
program instructions to output a set of offers to the customer based on the assigned customer segment.

9. The computer program product of claim 8, wherein program instructions to receive the first voice interaction, comprise:
program instructions to capture at least some portions of the first voice interaction between the customer and an e-commerce unit.

10. The computer program product of claim 8, wherein program instructions to analyze the set of voice data, comprise:
program instructions to determine patterns of the customer based on the voice analysis, wherein the patterns of the customer are based on at least purchasing preferences and purchasing history;
program instructions to determine patterns of an e-commerce unit based on at least supplier capability to provide products and services to the customer; and
program instructions to send the voice signature associated with the customer to a database.

11. The computer program product of claim 8, wherein program instructions to assign the voice signature to a customer segment, comprise:
program instructions to create a profile comprising the voice signature of the customer and customer patterns of the customer, wherein the customer patterns are at least purchasing preferences and purchasing history; and
responsive to analyzing the profile of the customer and considering an ability of an e-commerce unit to meet demands of the customer, program instructions to assign the customer segment to the customer.

12. The computer program product of claim 11, wherein program instructions to assign the customer segment to the customer, comprise:
program instructions to dynamically generate customer segments associated with the customer upon receiving new information pertaining to at least one of the customer and the e-commerce unit; and
program instructions to determine niche markets in conjunction with the capabilities of the e-commerce unit by examining the customer patterns.

13. The computer program product of claim 8, further comprising:
program instructions to receive a second voice interaction associated with the customer through at least one channel;
program instructions to analyze at least some portions of the second voice interaction using a voice analyzer; and
program instructions to match the at least some portions of the second voice interaction, with the generated voice signature.

14. The computer program product of claim 13, further comprising:
responsive to matching the at least some portions of the second voice interaction with the voice signature, program instructions to associate the customer segment assigned to the customer, based on the second voice interaction.

15. A computer system for customer segmentation, comprising:
one or more computer processors;
one or more computer readable storage media;
program instructions stored on the one or more computer readable storage media for execution by at least one of the one or more processors, the program instructions comprising:
program instructions to receive a first voice interaction from a customer;
program instructions to analyze a set of voice data deriving from the first voice interaction;
program instructions to generate a voice signature based on the analyzed set of voice data wherein the voice signature is assigned to a customer segment; and
program instructions to output a set of offers to the customer based on the assigned customer segment.

16. The computer system of claim 15, wherein program instructions to receive the first voice interaction, comprise:
program instructions to capture at least some portions of the first voice interaction between the customer and an e-commerce unit.

17. The computer system of claim 15, wherein program instructions to analyze the set of voice data comprise:
program instructions to determine patterns of the customer based on the voice analysis, wherein the patterns of the customer are based on at least purchasing preferences and purchasing history;
program instructions to determine patterns of an e-commerce unit based on at least supplier capability to provide products and services to the customer; and
program instructions to send the voice signature associated with the customer to a database.

18. The computer system of claim 15, wherein program instructions to assign the voice signature to a customer segment, comprise:
program instructions to create a profile comprising the voice signature of the customer and customer patterns of the customer, wherein the customer patterns are at least purchasing preferences and purchasing history; and
responsive to analyzing the profile of the customer and considering an ability of an e-commerce unit to meet demands of the customer, program instructions to assign the customer segment to the customer.

19. The computer system of claim 18, wherein program instructions to assign the customer segment to the customer, comprise:
program instructions to dynamically generate customer segments associated with the customer upon receiving new information pertaining to at least one of the customer and the e-commerce unit; and
program instructions to determine niche markets in conjunction with the capabilities of the e-commerce unit by examining the customer patterns.

20. The computer system of claim 15, further comprising:
program instructions to receive a second voice interaction associated with the customer through at least one channel;
program instructions to analyze at least some portions of the second voice interaction using a voice analyzer;
program instructions to match the at least some portions of the second voice interaction, with the generated voice signature; and
responsive to matching the at least some portions of the second voice interaction with the voice signature, program instructions to associate the customer segment assigned to the customer, based on the second voice interaction.
